(19) United States
(12) Patent Application Publication
(10) Pub. No.: US 2026/0177829 A1
(43) Pub. Date: Jun. 25, 2026

(54) EYEPIECE DEVICE AND WAVEGUIDE MODULE

(71) Applicant: THINKAR PTE. LTD., Singapore (SG)

(72) Inventors: Feng Wu, Taipei City (TW); Zhou Ye, Taipei City (TW)

(73) Assignee: THINKAR PTE. LTD., Singapore (SG)

(21) Appl. No.: 19/294,306

(22) Filed: Aug. 8, 2025

Related U.S. Application Data
(60) Provisional application No. 63/796,408, filed on Apr. 29, 2025.
(60) Provisional application No. 63/738,743, filed on Dec. 24, 2024.

(51) Int. Cl. G02B 27/01

(52) U.S. Cl. CPC G02B 27/0172; G02B 2027/0118; G02B 2027/0178

(57) ABSTRACT

An eyepiece device configured to display an image to an eye is provided. The eyepiece device includes a waveguide, an indentation layer, and a projection module. The waveguide has a first surface, a second surface opposite to the first surface, an input coupler located at the second surface, and an output coupler located at the second surface. The indentation layer is disposed on the first surface and has a third surface facing away from the waveguide, wherein the third surface has a plurality of indentations configured to scatter an ambient light incident thereon, so as to reduce interference with a user's perception of the image. The projection module is configured to project an image beam to the input coupler, wherein the image beam travels in the waveguide and is then transmitted to the eye through the output coupler. A waveguide module is also provided.

### CROSS-REFERENCE TO RELATED APPLICATION

This application claims the priority benefit of US provisional application serial no. 63/738,743, filed on December 24, 2024 and US provisional application serial no. 63/796,408, filed on April 29, 2025. The entirety of each of the above-mentioned patent applications is hereby incorporated by reference herein and made a part of this specification.

### BACKGROUND

### Technical Field

The present disclosure generally relates to an optical device and module and, in particular, to an eyepiece device and a waveguide module.

### Description of Related Art

Augmented reality (AR) glasses are capable of overlaying virtual images onto real-world scenes and have been widely applied in navigation, real-time information display, remote collaboration, and other scenarios. However, most current AR glasses are primarily optimized for indoor use. When users wear such devices outdoors, especially under strong sunlight, the virtual images often become difficult to see due to excessive ambient brightness, resulting in poor visibility and degraded user experience.

Solutions in the industry include increasing the display brightness or adding physical shades to block light. However, these approaches may lead to increased power consumption, user discomfort, or design constraints. Therefore, there is a pressing need for an approach to improve the usability and practicality of AR glasses in both indoor and outdoor environments.

### SUMMARY

Accordingly, the present disclosure is directed to an eyepiece device, which is suitable for use in both indoor and outdoor environments.

The present disclosure is directed to a waveguide module, which is suitable for use in both indoor and outdoor environments.

An embodiment of the present disclosure provides an eyepiece device configured to display an image to an eye. The eyepiece device includes a waveguide, an indentation layer, and a projection module. The waveguide has a first surface, a second surface opposite to the first surface, an input coupler located at the second surface, and an output coupler located at the second surface. The indentation layer is disposed on the first surface and has a third surface facing away from the waveguide, wherein the third surface has a plurality of indentations configured to scatter an ambient light incident thereon, so as to reduce interference with a user's perception of the image. The projection module is configured to project an image beam to the input coupler, wherein the image beam travels in the waveguide and is then transmitted to the eye through the output coupler.

An embodiment of the present disclosure provides a waveguide module configured to form part of an optical path for delivering an image beam to an eye. The waveguide module includes a waveguide and an indentation layer. The waveguide has a first surface, a second surface opposite to the first surface, an input coupler located at the second surface, and an output coupler located at the second surface, wherein the image beam enters the waveguide through the input coupler, travels in the waveguide, and leaves the waveguide through the output coupler. The indentation layer is disposed on the first surface and has a third surface facing away from the waveguide, wherein the third surface has a plurality of indentations configured to scatter an ambient light incident thereon, so as to reduce interference with a user's perception of the image beam.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic perspective view of an eyepiece device according to an embodiment of the present disclosure.

FIG. 2 is a schematic partial cross-sectional view of the eyepiece device shown in FIG. 1 according to an embodiment of the present disclosure.

FIG. 3 is a schematic rear view of a waveguide module shown in FIG. 2 according to an embodiment of the present disclosure.

FIG. 4 is a schematic partial cross-sectional view of the eyepiece device shown in FIG. 1 according to another embodiment of the present disclosure.

FIG. 5 is an electrical circuit block diagram of the eyepiece device in FIG. 1 according to an embodiment of the present disclosure.

### DESCRIPTION OF THE EMBODIMENTS

Reference will now be made in detail to the present embodiments of the present disclosure, examples of which are illustrated in the accompanying drawings. Wherever possible, the same reference numbers are used in the drawings and the description to refer to the same or like parts.

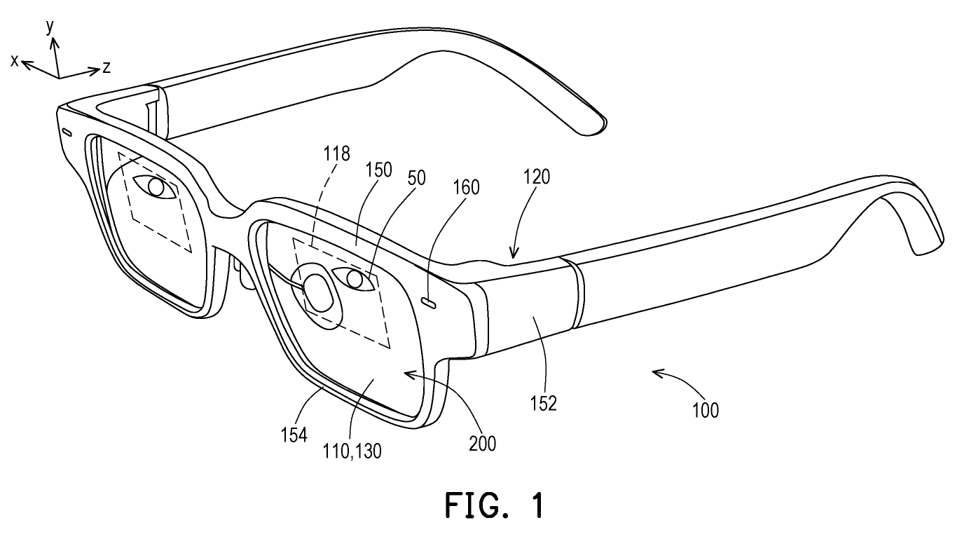

FIG. 1 is a schematic perspective view of an eyepiece device according to an embodiment of the present disclosure. Referring to FIG. 1, an eyepiece device 100 in this embodiment is configured to display an image to an eye 50, and includes a frame 150, a projection module 120, and a waveguide module 200. The waveguide module 200 and the projection module 120 are fixed on the frame 150. For example, the frame 150 includes rims 154 and temples 152 connected to the rims 154, a projection module 120 is disposed in or on a temple 152 of the frame 150, and a waveguide module 200 is disposed inside a rim 154 of the frame 150. The waveguide module 200 includes a waveguide 110 and an indentation layer 130, the details of which will be described as follows.

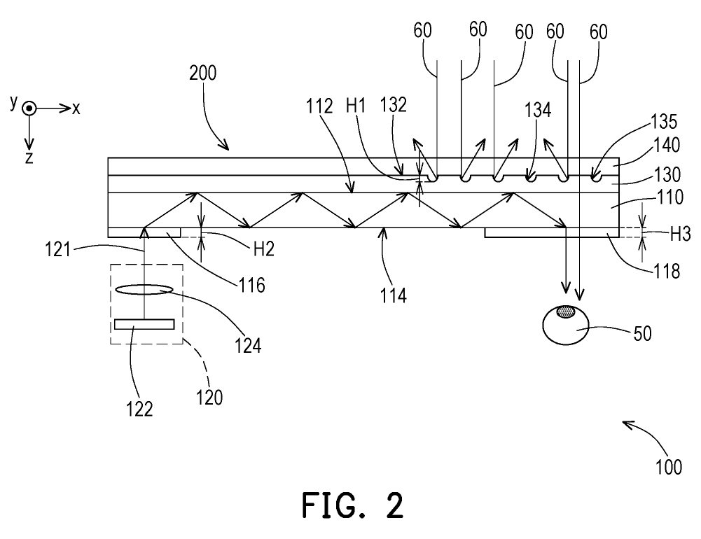

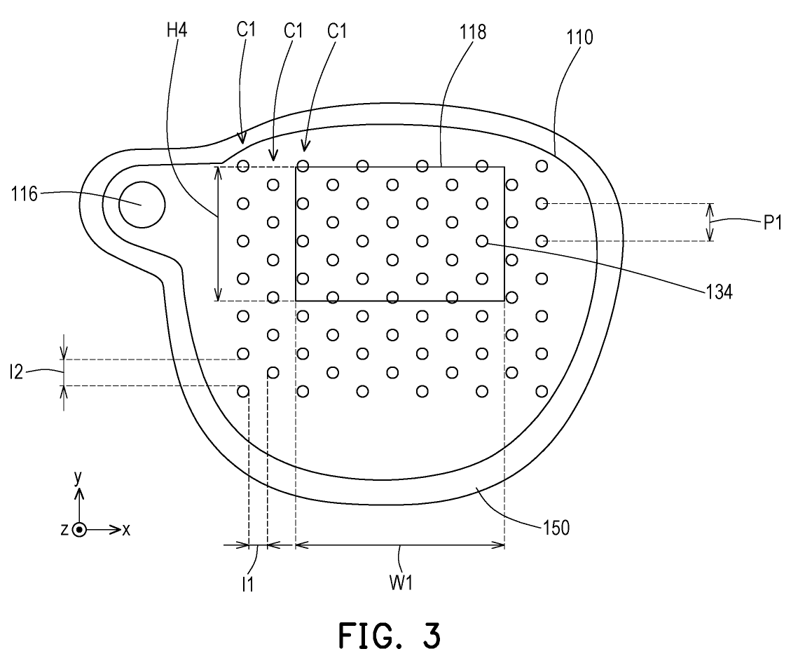

FIG. 2 is a schematic partial cross-sectional view of the eyepiece device shown in FIG. 1 according to an embodiment of the present disclosure, and FIG. 3 is a schematic rear view of a waveguide module shown in FIG. 2 according to an embodiment of the present disclosure. FIG. 2 shows a partial cross-section of the eyepiece device parallel to the x-z plane, and FIG. 3 shows a schematic view when viewing along the -z direction, wherein the z-direction is substantially parallel to the extending direction of the temple 152, and wherein the x-direction and the y-direction are two orthogonal directions that together define a plane substantially parallel to the main surface of the waveguide module 200. The x-direction, the y-direction, and the z-direction are substantially perpendicular to one another. Referring to FIG. 2 and FIG. 3, the eyepiece device 100 includes the waveguide 110, a projection module 120, and the indentation layer 130. The waveguide 110 has a first surface 112, a second surface 114 opposite to the first surface 112, an input coupler 116 located at the second surface 114, and an output coupler 118 located at the second surface 114. In some embodiments, the input coupler 116 is, for example, an input grating, and the output coupler 118 is, for example, an output grating. The projection module 120 is configured to project an image beam 121 to the input coupler 116, wherein the image beam 121 travels in the waveguide 110 and is then transmitted to the eye 50 through the output coupler 118. In some embodiments, the projection module 120 includes a display module 122 and a projection lens 124. The display module 122 is configured to provide the image beam 121, and the projection lens 124 is configured to project the image beam 121 to the input coupler 116. In some embodiments, the display module 122 is, for example, an organic light-emitting diode (OLED) display, a micro light-emitting diode display (micro-LED display), an liquid-crystal-on-silicon panel (LCOS panel), a digital micro-mirror device (DMD), a transmissive liquid crystal panel, any other suitable display panel, or any other suitable spatial light modulator (SLM).

The indentation layer 130 is disposed on the first surface 112 and has a third surface 132 facing away from the waveguide 110, wherein the third surface 132 has a plurality of indentations 134. In some embodiments, the waveguide 110 and the indentation layer 130 may form the waveguide module 200, and the waveguide module 200 is configured to form part of an optical path for delivering an image beam 121 to the user’s eye 50.

In some embodiments, the refractive index of the indentation layer 130 is less than the refractive index of the waveguide 110. As a result, the image beam 121 enters the waveguide 110 through the input coupler 116, is then totally internally reflected by the first surface 112 and the second surface 114 alternately to travel in the waveguide 110, then leaves the waveguide 110 through the output coupler 118, and is then transmitted to the eye 50 of a user. Therefore, when the user wears the eyepiece device 100 in FIG. 1 and sees through the waveguide 110 and the indentation layer 130, the user may see a virtual image in front formed by the image beam 121. At the same time, an ambient light 60 from an object in the environment travels through the indentation layer 130 and the waveguide 110 in sequence and then reaches the eye 50 of the user. Consequently, the user may see the object in the environment and the virtual image at the same time to realize an augmented reality function of the eyepiece device 100. In some embodiments, the eyepiece device 100 is augmented reality glasses. In some embodiments, the first surface 112 and the third surface 132 face away from the eye 50, and the second surface 114 faces the eye 50.

In the eyepiece device 100 and the waveguide module 200 in this embodiment, the third surface 132 of the indentation layer 130 facing away from the waveguide 110 has a plurality of indentations 134. The indentations 134 are capable of scattering the ambient light 60 from the environment and thus reducing the intensity of the ambient light 60 from the environment received by the eye 50, so as to reduce interference with a user's perception of the image displayed by the projection module 120. For example, as shown in FIG. 2, a part of the ambient light 60 travels to the indentations 134 and is then scattered by the indentations 134 and does not travel to the eye 50, while another part of the ambient light 60 which does not travel to the indentations 134 passes through the indentation layer 130 and the waveguide 110 and arrives at the eye 50. Therefore, the problem of the virtual images becoming difficult to see due to excessive ambient brightness in the outdoor environment is prevented. As a result, the eyepiece device 100 and the waveguide module 200 in this embodiment are suitable for use in both indoor and outdoor environments. In some embodiments, since the indentations 134 can reduce the intensity of the ambient light 60, the brightness of the virtual image does not need to be increased to overcome the aforementioned problem due to excessive ambient brightness in the outdoor environment, and the energy of increasing the brightness of the virtual image may thus be saved, and the power consumption of eyepiece device 100 is reduced, and the battery life of the eyepiece device 100 is increased.

In some embodiments, the distribution area of the indentations 134 covers the area of the output coupler118 as shown in FIG. 2 and FIG. 3 since the eye 50 receives the image beam 121 only through the output coupler 118, and therefore ambient light entering through this area is more likely to interfere with image perception. In some embodiments, the distribution area of the indentations 134 coincides with the area of the output coupler 118. In other words, the indentations 134 are distributed in an area that overlaps with the output coupler 118 when the eyepiece device 100 is viewed from the front side or the rear side of the eyepiece device 100. That is, the indentations 134 are located only within the area of the output coupler 118. This arrangement is sufficient to reduce the ambient light 60 from reaching the eye 50 and interfering with the viewing of the virtual image since the eye 50 can see the image beam 121 only through the output coupler 118. In an embodiment, the output coupler 118 has a width W1 of 20 mm and a length H4 of 14 mm. In some embodiments, the indentations 134 are arranged in an array, and neighboring indentations 134 are spaced apart from each other by a distance P1 ranging from 2 millimeter (mm) to 4 mm. In some embodiments, the indentations 134 are arranged in an array, the array includes columns C1 spaced apart at a first interval I1, and indentations 134 in each column C1 are spaced apart at a second interval I2. In some embodiments, the indentations 134 in adjacent columns C1 are vertically offset, such that each indentation 134 is located halfway between two vertically adjacent indentations 134 in a neighboring column C1.

In some embodiments, each of the indentations 134 has a freeform surface 135. For example, the indentations are square-shaped, round-shaped or have other shapes, or have various suitable depths. In addition, in some embodiments, the depth H1 of each of the indentations 134 is greater than the height H2 of the input coupler 116, and is greater than the height H3 of the output coupler 118.

In some embodiments, the indentations 134 formed on the third surface 132 of the indentation layer 130 are arranged and shaped to scatter or diffuse ambient light 60 incident thereon. The indentations 134 may be circular, elliptical, or irregular in shape, and may be arranged in an array with a spacing of about 2 to 4 millimeters. Such geometric configuration facilitates scattering of ambient light 60 and reduces the amount of ambient light 60 transmitted through the indentation layer 130 and the waveguide 110 to the eye 50, thereby minimizing interference with viewing of the image.

In some embodiments, the eyepiece device 100 further includes a transparent layer 140 covering the third surface 132 of the indentation layer 130 and configured to protect the indentations 134. The transparent layer 140 is, for example, a protection layer or shield to protect the indentations 134. The waveguide 110 and the indentation layer 130, or the waveguide 110, the indentation layer 130, and the transparent layer 140 can be manufactured by the same process equipment and stamped together to form a module, e.g. the waveguide module 200, so that they can be manufactured, produced, sold, and replaced in a modular manner.

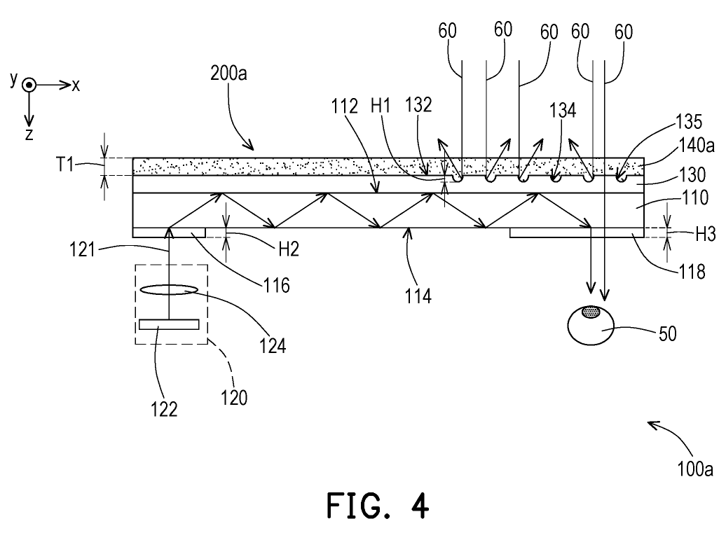

FIG. 4 is a schematic partial cross-sectional view of the eyepiece device shown in FIG. 1 according to another embodiment of the present disclosure. Referring to FIG. 4, the eyepiece device 100a and the waveguide module 200a in this embodiment are similar to the eyepiece device 100 and the waveguide module 200 in FIG. 2, and the main difference therebetween is as follows. In the eyepiece device 100a and the waveguide module 200a in this embodiment, the eyepiece device 100a includes a photochromic layer 140a instead of the transparent layer 140 in FIG. 2, and the photochromic layer 140a is disposed on the third surface 132 of the indentation layer 130. The waveguide 110, the indentation layer 130, and the photochromic layer 140a can be manufactured by the same process equipment and stamped together to form a module, i.e. the waveguide module 200a, so that they can be manufactured, produced, sold, and replaced in a modular manner. In some embodiments, the photochromic layer 140a is an ultraviolet responsive layer, and the transmittance of the photochromic layer 140a for visible light is decreased in response to an increase of ultraviolet incident on the photochromic layer 140a.

In detail, the photochromic layer 140a includes photochromic molecules. Upon exposure to ultraviolet (UV) radiation, the photochromic molecules undergo a reversible structural transformation. As a result of this structural transformation, the modified molecule exhibits an increased absorption in the visible light spectrum. This causes a reduction in the amount of visible light transmitted through the photochromic layer 140a, which is perceived by the eye 50 as a darkening or tinting of the photochromic layer 140a. The photochromic response is reversible; when UV exposure ceases, the molecules gradually return to their original structure, restoring the high transmittance and transparency of the photochromic layer 140a. Accordingly, when the user moves from an indoor environment to an outdoor setting, the photochromic layer 140a reduces the intensity of ambient light 60 passing through the eyepiece device 100a and reaching the eye 50 of the user. This reduction in brightness helps prevent ambient light 60 from overwhelming or interfering with the visibility of the AR display content, i.e. the aforementioned virtual image formed by the image beam 121. Conversely, when the user returns to an indoor environment, the photochromic layer 140a becomes transparent again, allowing the user to clearly view both the real-world surroundings and the virtual content overlaid thereon. Thus, the photochromic layer 140a automatically adjusts its light transmittance in response to the intensity of ambient UV light, thereby enhancing the clarity and visibility of virtual imagery under various lighting conditions.

In some embodiments, the photochromic layer 140a darkens within approximately 20 seconds after exposure to UV light, and returns to a transparent state within approximately 30~40 seconds after the UV exposure ceases. Besides, the photochromic layer 140a can also protect the indentations 134.

In some embodiments, the waveguide 110 may be a substrate made of, for example, polymer (e.g., resin or plastic), glass, or silicon carbide (SiC), using techniques including etching, thermal imprinting, or nanoimprint lithography. In some embodiments, the waveguide 110 made of polymer may be thicker than the waveguide 110 made of glass or SiC. For example, the waveguide 110 made of polymer may be around 1.5 mm thick, while the waveguide 110 made of glass or SiC may be approximately 1.0 mm thick.

In some embodiments, the photochromic layer 140a may be formed by either coating a photochromic material directly onto the indentation layer 130 or laminating (bonding) a UV-responsive film onto the third surface 132 of the indentation layer 130.

In an alternative embodiment, the photochromic layer 140a may be directly disposed on the waveguide 110, and the waveguide module 200a may not include the indentation layer 130. Even without the indentation layer 130, the waveguide module 200a may still reduce ambient light 60 traveling to the eye 50 because the transmittance of the photochromic layer 140a for visible light decreases in response to increased ultraviolet exposure. In some instances, the integration of the photochromic layer 140a onto the waveguide 110 introduces a potential issue of image ghosting. When exposed to UV light, the photochromic layer 140a darkens due to its photochromic properties, which increases its reflectivity to certain wavelengths of visible light. As the image beam 121 emitted from the projection module 120 propagates through the waveguide 110 toward the user’s eye 50, a portion of the image beam 121 may travel to the darkened photochromic layer 140a, be transmitted inside the photochromic layer 140a, and then be reflected back toward the waveguide 110. This reflected image beam 121 can re-enter the waveguide 110 and eventually reach the user’s eye 50 slightly delayed or misaligned relative to the intended path of the image beam 121. As a result, the user may perceive double image or ghost image.

To address this issue, in some embodiments, reflectivity of the photochromic layer 140a is reduced by precisely controlling the thickness of the photochromic layer 140a. By adjusting the thickness within a predetermined range, the optical interference effects and reflective characteristics of the photochromic layer 140a can be managed to minimize undesirable back reflections and suppress image ghosting. In some embodiments, the thickness T1 of the photochromic layer 140a ranges from 0.1 mm to 1 mm. In some embodiments, the thickness of the photochromic layer 140a may be adjusted according to the thickness of the waveguide 110 to reduce internal reflections and minimize ghost images. For example, a thicker waveguide 110 (e.g., the waveguide 110 made of polymer) may require a correspondingly thicker photochromic layer 140a to maintain low reflectivity.

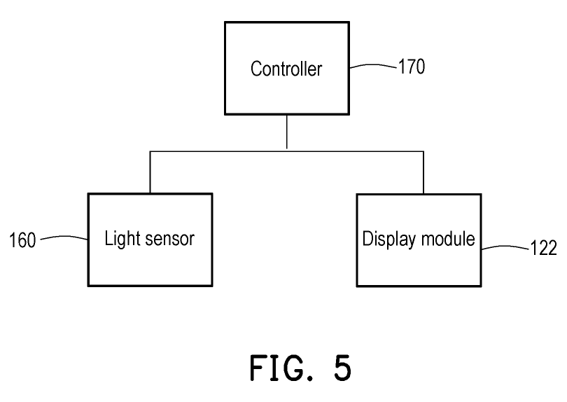

FIG. 5 is an electrical circuit block diagram of the eyepiece device in FIG. 1 according to an embodiment of the present disclosure. In some examples, for an eyepiece device without an indentation layer and/or a photochromic layer (such as the indentation layer 130 and the photochromic layer 140a shown in the embodiments of FIG. 2 and FIG. 4), to ensure visibility under bright sunlight, the projection module of the eyepiece device often operates at full brightness (e.g., 100% brightness) when the eyepiece device is used outdoor. However, for the eyepiece devices 100 and 100a as disclosed in the embodiments of the present disclosure, in some embodiments, because the indentation layer 130 and/or the photochromic layer 140a reduce the amount of ambient light 60 that passes through the eyepiece device 100a into the user’s eye 50, the projection module 120 may operate at reduced brightness levels, thereby lowering power consumption and extending battery life. In some embodiments, referring to FIGS. 1 or 4 and 5, the eyepiece device 100 or the eyepiece device 100a includes a light sensor 160 and a controller 170 electrically connected to the light sensor 160 and the display module 122 (or the projection module 120). The light sensor 160 is configured to detect the brightness of the ambient light 60, and the controller 170 may determine or adjust the brightness level of the display module 122 (or the projection module 120) according to the brightness of ambient light 60.

In some embodiments, the controller 170 is, for instance, a central processing unit (CPU), a microprocessor, a digital signal processor (DSP), a programmable controller, a programmable logic device (PLD), any other similar device, or a combination of these devices, which should not be construed as a limitation in the present disclosure. Besides, in an embodiment, the various functions of the controller 170 can be implemented in form of a plurality of codes. These codes can be stored in a memory and executed by the controller 170. Alternatively, in some embodiments, the various functions of the controller 170 can be implemented in form of one or more circuits. Whether the various functions of the controller 170 are implemented in form of software or hardware should not be construed as a limitation in the present disclosure.

In conclusion, in the eyepiece device and the waveguide module according to the embodiment of the present disclosure, the third surface of the indentation layer facing away from the waveguide has a plurality of indentations. The indentations are capable of scattering light from the environment and thus reducing the intensity of the light from the environment received by the eye. Therefore, the problem of the virtual images becoming difficult to see due to excessive ambient brightness in the outdoor environment is prevented. As a result, the eyepiece device and the waveguide module according to the embodiment of the present disclosure is suitable for use in both indoor and outdoor environments.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An eyepiece device configured to display an image to an eye, the eyepiece device comprising:
a waveguide having a first surface, a second surface opposite to the first surface, an input coupler located at the second surface, and an output coupler located at the second surface;
an indentation layer disposed on the first surface and having a third surface facing away from the waveguide, wherein the third surface has a plurality of indentations configured to scatter an ambient light incident thereon, so as to reduce interference with a user's perception of the image; and
a projection module configured to project an image beam to the input coupler, wherein the image beam travels in the waveguide and is then transmitted to the eye through the output coupler.

2. The eyepiece device of claim 1, wherein the indentations are arranged and shaped to scatter the ambient light, thereby reducing the amount of the ambient light transmitted through the indentation layer and the waveguide to the eye.

3. The eyepiece device of claim 1, wherein the indentations are distributed in an area that overlaps with the output coupler when the eyepiece device is viewed from a front side or a rear side of the eyepiece device.

4. The eyepiece device of claim 1, wherein a refractive index of the indentation layer is less than a refractive index of the waveguide.

5. The eyepiece device of claim 1 further comprising a light sensor and a controller electrically connected to the light sensor and the projection module, wherein the light sensor is configured to detect brightness of the ambient light, and the controller is configured to adjust a brightness level of the projection module based on the detected brightness of the ambient light.

6. The eyepiece device of claim 1, wherein each of the indentations has a freeform surface.

7. The eyepiece device of claim 1, wherein the indentations are arranged in an array, the array includes columns spaced apart at a first interval, and indentations in each column are spaced apart at a second interval, wherein indentations in adjacent columns are vertically offset, such that each of the indentations is located halfway between two vertically adjacent indentations in a neighboring column.

8. The eyepiece device of claim 1 further comprising a transparent layer covering the third surface of the indentation layer and configured to protect the indentations.

9. The eyepiece device of claim 1 further comprising a photochromic layer disposed on the third surface of the indentation layer.

10. The eyepiece device of claim 9, wherein the photochromic layer is an ultraviolet responsive layer, and a transmittance of the ultraviolet responsive layer for visible light is decreased in response to an increase of ultraviolet incident on the ultraviolet responsive layer.

11. A waveguide module configured to form part of an optical path for delivering an image beam to an eye, the waveguide module comprising:
a waveguide having a first surface, a second surface opposite to the first surface, an input coupler located at the second surface, and an output coupler located at the second surface, wherein the image beam enters the waveguide through the input coupler, travels in the waveguide, and leaves the waveguide through the output coupler; and
an indentation layer disposed on the first surface and having a third surface facing away from the waveguide, wherein the third surface has a plurality of indentations configured to scatter an ambient light incident thereon, so as to reduce interference with a user's perception of the image beam.

12. The waveguide module of claim 11, wherein the indentations are arranged and shaped to scatter the ambient light, thereby reducing the amount of the ambient light transmitted through the indentation layer and the waveguide to the eye.

13. The waveguide module of claim 11, wherein the indentations are arranged in an array, and the indentations are spaced apart from each other by a distance ranging from 2 mm to 4 mm.

14. The waveguide module of claim 11, wherein a refractive index of the indentation layer is less than a refractive index of the waveguide.

15. The waveguide module of claim 11, wherein a depth of each of the indentations is greater than a height of the input coupler, and is greater than a height of the output coupler.

16. The waveguide module of claim 11, wherein each of the indentations has a freeform surface.

17. The waveguide module of claim 11, wherein the indentations are arranged in an array, the array includes columns spaced apart at a first interval, and indentations in each column are spaced apart at a second interval, wherein indentations in adjacent columns are vertically offset, such that each of the indentations is located halfway between two vertically adjacent indentations in a neighboring column.

18. The waveguide module of claim 11 further comprising a transparent layer covering the third surface of the indentation layer and configured to protect the indentations.

19. The waveguide module of claim 11 further comprising a photochromic layer disposed on the third surface of the indentation layer.

20. The waveguide module of claim 19, wherein the photochromic layer is an ultraviolet responsive layer, and a transmittance of the ultraviolet responsive layer for visible light is decreased in response to an increase of ultraviolet incident on the ultraviolet responsive layer.
